(19) United States
(12) Patent Application Publication
(10) Pub. No.: US 2024/0322329 A1
(43) Pub. Date: Sep. 26, 2024

(54) STRUCTURAL BATTERY PACK WITH ENERGY ABSORPTION FEATURES

(71) Applicant: Apple Inc., Cupertino, CA (US)

(72) Inventors: Evan D. Maley, Redwood City, CA (US); Andrew J. Gunnion, Campbell, CA (US); Nivay Anandarajah, San Leandro, CA (US); Daniel T. Williams, San Jose, CA (US); Yu-Hung Li, Sunnyvale, CA (US); Anish Shah, Milpitas, CA (US); Matthew I. Woods, Airlie Beach (AU)

(21) Appl. No.: 18/582,440

(22) Filed: Feb. 20, 2024

Related U.S. Application Data
(60) Provisional application No. 63/453,413, filed on Mar. 20, 2023.

(51) Int. Cl. H01M 50/242; H01M 50/204; H01M 50/249; H01M 50/367

(52) U.S. Cl. CPC H01M 50/242; H01M 50/367; H01M 50/204; H01M 50/249; H01M 2220/20

(57) ABSTRACT

A battery pack includes an enclosure defining an enclosure interior, a stack of battery cells disposed in the enclosure interior between a first wall of the enclosure and a second wall of the enclosure, and a side beam extending from the first wall to the second wall and adjacent to the stack of battery cells. The side beam includes a plurality of interconnected elements forming a web, where a portion of the web is configured to collapse in response to a force against a side of the battery pack exceeding a threshold force.

### CROSS-REFERENCE TO RELATED APPLICATIONS

This application claims priority to U.S. Application No. 63/453,413, filed Mar. 20, 2023, entitled “STRUCTURAL BATTERY PACK WITH ENERGY ABSORPTION FEATURES,” which is incorporated by reference herein in its entirety for all purposes.

### BACKGROUND

The present disclosure relates generally to a battery pack, and more specifically to energy absorption features (e.g., a side beam having interconnected elements forming a web) of the battery pack.

A battery pack may include a number of battery cells, such as rechargeable or secondary battery cells, disposed in an enclosure of the battery pack and configured to generate a charge having a voltage and current for powering a load. For example, the battery cells may be coupled in series such that individual voltages of the battery cells are combined to generate a charge having a total voltage, or in parallel such that individual currents of the battery cells are combined to generate a charge having a total current. In some embodiments, series and parallel couplings are employed between various battery cells of the battery pack to generate a total voltage and total current compatible with the load receiving the charge.

Traditional battery packs may employ various componentry configured to protect the battery cells from external forces. Additionally or alternatively, in certain traditional systems, componentry may be integrated with a structure corresponding to a load powered by the battery pack, where the componentry is configured to protect the battery pack from external forces. Unfortunately, such traditional componentry may be expensive and/or susceptible to failure.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a battery pack includes an enclosure defining an enclosure interior, a stack of battery cells disposed in the enclosure interior between a first wall of the enclosure and a second wall of the enclosure, and a side beam extending from the first wall to the second wall and adjacent to the stack of battery cells. The side beam includes a plurality of interconnected elements forming a web, where a portion of the web is configured to collapse in response to a force against a side of the battery pack exceeding a threshold force.

In another embodiment of the present disclosure, an enclosure assembly of a battery pack includes a body portion defining an enclosure interior configured to receive battery cells, a lid configured to be coupled to the body portion to enclose the battery cells within the enclosure interior, and a side beam coupled to or forming a part of the body portion such that the side beam extends from a bottom of the body portion to the lid. The side beam includes a plurality of interconnected elements forming a web, and a portion of the web is configured to collapse in response to a force against the side beam exceeding a threshold force.

In yet another embodiment of the present disclosure, a battery pack includes an enclosure defining an enclosure interior. A first side beam defines a first side of the enclosure and includes first sheet metal, where a first portion of the first sheet metal is configured to controllably collapse in response to a first force against the first side beam. A second side beam defines a second side of the enclosure and includes second sheet metal, where a second portion of the second sheet metal is configured to controllably collapse in response to a second force against the second side beam. A lid of the enclosure extends from the first side beam to the second side beam. A wall of the enclosure, opposing the lid of the enclosure, extends from the first side beam to the second side beam. Battery cells are disposed in the enclosure interior between the first second beam and the second side beam. The battery cells are structurally coupled to and electrically isolated from the lid and the wall.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic overhead view of a battery pack having an enclosure, battery cells disposed in the enclosure, a first webbed structure, and a second webbed structure, according to embodiments of the present disclosure;

FIG. 2 is an exploded perspective view of the battery pack of FIG. 1, according to embodiments of the present disclosure;

FIG. 3 is a cross-sectional front view of the battery pack of FIG. 1, according to embodiments of the present disclosure;

FIG. 4 is a cross-sectional perspective view of the battery pack of FIG. 1, according to embodiments of the present disclosure;

FIG. 5 is a cross-sectional front view of the battery pack of FIG. 1, where a first portion of battery cell terminals faces the first webbed structure, a second portion of battery cell terminals faces the second webbed structure, and shunting features are employed to protect the battery cell terminals, according to embodiments of the present disclosure;

FIG. 6 is a cross-sectional perspective view of the battery pack of FIG. 1 and structural componentry corresponding to a load powered by the battery pack, including a deformable zone and a safety cage adjacent the deformable zone, according to embodiments of the present disclosure;

FIG. 7 is a cross-sectional front view of the battery pack of FIG. 1, according to embodiments of the present disclosure; and

FIG. 8 is a cross-sectional front view of a battery pack having a side beam including sheet metal (e.g., stamped or roll formed sheet metal), according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is generally directed to a battery pack. More specifically, the present disclosure is directed to a battery pack having various energy absorption features configured to protect battery cells of the battery pack from external forces, such as side beams (e.g., extruded side beams) having a web formed by interconnected elements (e.g., horizontal and vertical interconnected elements) and disposed across (or forming a part of) opposing lateral sides of an enclosure of the battery pack.

For example, the battery pack may include a number of battery cells disposed in an enclosure interior defined by an enclosure. The enclosure may include a lid and a body having an opening configured to receive the battery cells and to be closed by the lid. A first side beam may extend between the lid and a bottom side (e.g., heat exchanger side) of the body of the enclosure. The first side beam may extend adjacent to, or form a part of, a first lateral side of the body of the enclosure. Further, a second side beam may extend between the lid and the bottom side of the body of the enclosure. The second side beam may extend adjacent to, or form a part of, a second lateral side of the body of the enclosure. In this way, the battery cells may be disposed between the lid of the enclosure and the bottom side of the body of the enclosure (e.g., from top-to-bottom), and the battery cells may be disposed between the first and second lateral sides of the body of the enclosure (e.g., from side-to-side). In some embodiments, the bottom side of the body of the enclosure may include a heat exchanger, such as an active heat exchanger configured to receive a heat exchange fluid. While first and second side beams are referred to above and below, other processes besides extrusion may be employed. For example, the side beams may be produced via stamped sheet metal assemblies, roll formed sheet metal assemblies, and/or other types of manufacturing processes.

The first side beam may include, or be formed by, first interconnected elements forming a first web. The second side beam may include, or be formed by, second interconnected elements forming a second web. In some embodiments, the first web may include a first grid-like arrangement (e.g., formed by the first interconnected elements) and the second web may include a second grid-like arrangement (e.g., formed by the second interconnected elements). For example, the first web may include first horizontal interconnected elements and first vertical interconnected elements that intersect to form various first channels (e.g., enclosed pockets of a medium, such as air, having a density less than the first horizontal and vertical interconnected elements) corresponding to the first side beam. Likewise, the second interconnected elements may include second horizontal interconnected elements and second vertical interconnected elements that intersect to form various second channels (e.g., enclosed pockets of a medium, such as air, having a density less than the second horizontal and vertical interconnected elements) corresponding to the second side beam. In general, at least a portion of the first web of the first side beam may be configured to controllably collapse in response to a force (e.g., side force, front force, rear force, small overlap, etc.) against the first side beam, and at least a portion of the second web of the second side beam may be configured to controllably collapse in response to a force (e.g., a side force, front force, rear force, small overlap, etc.) against the second side beam.

The collapsing or crushing of the first and second webs may be a progressive, sequence independent collapsing or crushing. In so collapsing, the first web of the first side beam and/or the second web of the second side beam may absorb the respective force(s) and protect the battery cells of the battery pack from such respective force(s). It should be noted that the first side beam and the second side beam may include a ductile material that can absorb energy through plastic strain and facilitate the above-described controllable collapsing. For example, the ductile material may be sufficient for sustaining significant plastic deformation before fracture and/or may include a high elongation before break value. Examples of the ductile material may include stamped or extruded aluminum (e.g., heat treated 5000, 6000, and/or 7000 series), die cast aluminum (e.g., including specific grades formulated for high elongation before break), stamped steel (e.g., advanced high strength steels, press hardened steels, and/or mild steels), injection molded structural plastics (e.g., plastics with chopped glass or carbon filler formulated for high elongation before break), compression molded composites (e.g., composites with continuous glass or carbon fibers formulated for high elongation before break), and the like.

The first web (e.g., formed by the first interconnected elements) and the second web (e.g., formed by the second interconnected elements) may include specific architectures configured to oppose or mitigate an impact of the force(s) against the battery pack. For example, the first interconnected elements of the first web may be more closely spaced with respect to each other adjacent to the battery cells than away from the battery cells, as it is presently recognized that such an architecture of the first side beam may improve physical resistance against mechanical loads or forces (e.g., side forces, front forces, rear forces, small overlaps, torsional loads, bending loads, etc.) against or associated with the battery pack. The second interconnected elements of the second web and corresponding second side beam may be similarly arranged. In certain embodiments, the first and second side beams (and respective first and second webs) may be formed via an extrusion process. In other embodiments, the first and second side beams may be formed via a stamped sheet metal process, a roll formed sheet metal process, or other techniques.

Further, each of the first and second side beams may be fastened to a body sill structure corresponding to the load powered by the battery pack. For example, a two-plane fastening assembly may fasten the first side beam to the body sill structure at a first location and a second location offset from the first location. The first location may be disposed toward a top of the first side beam and the second location may be disposed toward a bottom of the first side beam. A similar fastening assembly may be employed between the second side beam and the body sill structure. The above-described features, described in detail below with reference to the drawings, may improve an ability of the battery pack to absorb and mitigate mechanical loads or forces (e.g., side forces, front forces, rear forces, small overlaps, torsional loads, bending loads, etc.) relative to traditional embodiments.

Further, at least one of the first side beam or the second side beam may include a venting channel configured to receive gases (e.g., electrolyte gases) vented from one or more of the battery cells. For example, as previously described, the first side beam may include first horizontal and first vertical interconnected elements that intersect to form various channels, where one of the various channels may corresponding to the venting channel. The venting channel may be fluidly coupled with one or more vents of the battery cells (e.g., via a vent opening in one of the first vertical interconnected elements of the first side beam) such that the venting channel can receive the vented gases. The venting channel may also be arranged to direct the vented gases to a safe location. These and other features of the battery pack are described in detail below.

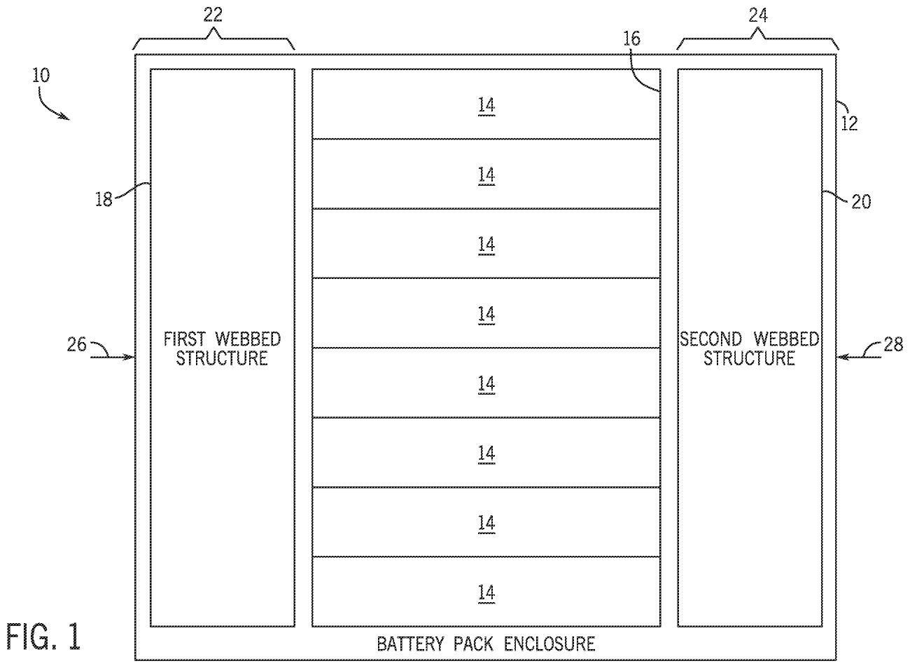

FIG. 1 is a schematic overhead view of an embodiment of a battery pack 10 having an enclosure 12, battery cells 14 disposed in an enclosure interior 16 defined by the enclosure 12, a first webbed structure 18, and a second webbed structure 20. The first webbed structure 18 may correspond to a first side beam of the battery pack 10, and the second webbed structure 20 may correspond to a second side beam of the battery pack 10. The first and second webbed structures 18, 20 corresponding to the first and second side beams, respectively, may be formed via an extrusion process in certain embodiments of the present disclosure. For example, the extrusion process may generate first interconnected elements forming the first webbed structure 18 and second interconnected elements forming the second webbed structure 20.

The battery cells 14, sometimes referred to as electrochemical cells, may include lithium-ion (Li-ion) cells (e.g., lithium iron phosphate (LFP) cells), nickel-metal hydride (NiMH) cells, nickel-cadmium (NiCd) cells, lead-acid cells, or other types of rechargeable, secondary battery cells. Although not shown in the illustrated embodiment, the battery cells 14 may be coupled via bus bars extending between terminals of the battery cells 14. For example, the battery cells 14 may be coupled in series, in parallel, or in a combination of series and parallel (e.g., certain of the battery cells 14 may be coupled in series, and certain of the battery cells 14 may be coupled in parallel).

As shown, the first webbed structure 18 may be formed in (or attached to) a first side 22 of the enclosure 12. Further, the second webbed structure 20 may be formed in (or attached to) a second side 24 of the enclosure 12 opposing the first side 22 of the enclosure 12. In this way, the battery cells 14 may be disposed between the first webbed structure 18 and the second webbed structure 20. In general, the first webbed structure 18 may be configured to absorb a first force 26 against the first side 22 of the enclosure 12. For example, first interconnected elements of the first webbed structure 18 may be configured to collapse in response to the first force 26. The second webbed structure 20 may be configured to absorb a second force 28 against the second side 24 of the enclosure 12. For example, second interconnected elements of the second webbed structure 20 may be configured to collapse in response to the second force 28. The collapsible portions of the first and second webbed structures 18, 20 may protect the battery cells 14 from the first and second forces 26, 28, respectively.

In certain embodiments, the first webbed structure 18 (e.g., first side beam) and the second webbed structure 20 (e.g., second side beam) may include a ductile material that can absorb energy through plastic strain and facilitate the above-described controllable collapsing. As previously described, the ductile material may be sufficient for sustaining significant plastic deformation before fracture and/or may include a high elongation before break value. Examples of the ductile material may include stamped or extruded aluminum (e.g., heat treated 5000, 6000, and/or 7000 series), die cast aluminum (e.g., including specific grades formulated for high elongation before break), stamped steel (e.g., advanced high strength steels, press hardened steels, and/or mild steels), injection molded structural plastics (e.g., plastics with chopped glass or carbon filler formulated for high elongation before break), compression molded composites (e.g., composites with continuous glass or carbon fibers formulated for high elongation before break), and the like. In general, the above-described collapsing may be a progressive, sequence independent collapsing.

While the first force 26 against the first side 22 and the second force 28 against the second side 24 are provided as examples in accordance with the present disclosure, energy absorption with respect to other types of forces (e.g., front force, rear force, small overlap, torsional forces, bending forces, etc.) is also contemplated herein. As described in detail below with reference to later drawings, certain architectures of the first webbed structure 18 and the second webbed structure 20 may improve energy absorption of the first and second forces 26, 28, respectively, relative to traditional embodiments.

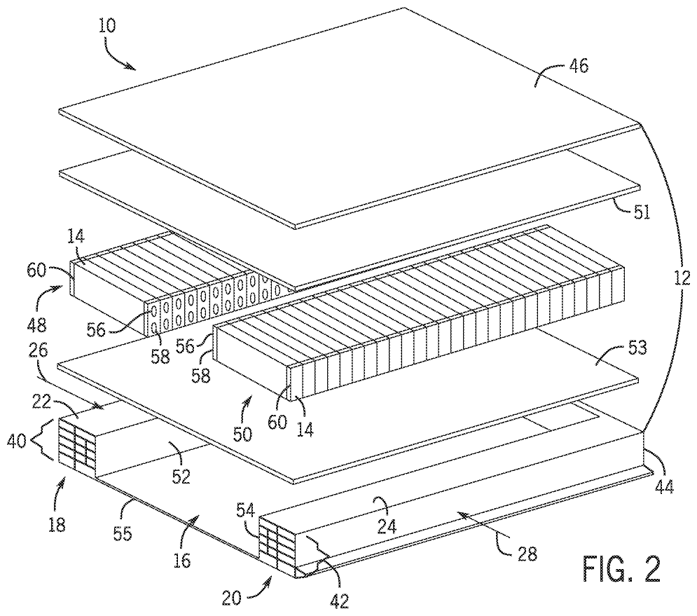

FIG. 2 is an exploded perspective view of an embodiment of the battery pack 10 of FIG. 1, including a more detailed illustration of various aspects of the battery pack 10, such as the first webbed assembly 18 (e.g., first web, first webbed structure) corresponding to a first side beam 40 (e.g., first extruded side beam) and the second webbed assembly 20 (e.g., second web, second webbed structure) corresponding to a second side beam 42 (e.g., second extruded side beam). As shown, the first webbed assembly 18 may be formed by first interconnected elements and the second web structure 20 may be formed by second interconnected elements. More detailed aspects of the first and second interconnected elements will be described in detail below with reference to later drawings. While certain portions of the description below refer to the first side beam 40 and the second side beam 42 being formed by an extrusion process, it should be understood that processes other than extrusion may be employed. For example, the first side beam 40 and the second side beam 42 may be formed via stamped sheet metal assemblies, roll formed sheet metal assemblies, etc.

In the illustrated embodiment, the battery pack 10 includes the enclosure 12 and the battery cells 14 configured to be disposed in the enclosure interior 16 defined by the enclosure 12. For example, the enclosure 12 in FIG. 2 includes a body 44 defining the enclosure interior 16 and a lid 46 configured to be coupled to the body 44, thereby enclosing the battery cells 14 within the enclosure interior 16. As shown, the battery cells 14 may be arranged in a first stack 48 and a second stack 50, although other arrangements are also possible (e.g., one stack of the battery cells 14, three stacks of the battery cells 14, four stacks of the battery cells 14, or more stacks of the battery cells 14). As shown, the first stack 48 and the second stack 50 may be separated by a cavity in the enclosure interior 16. In certain embodiments, a first coating and adhesive assembly 51 may extend between the lid 46 and the battery cells 14, and a second coating and adhesive assembly 53 may extend between the battery cells 14 and a bottom 55 of the body 44 of the enclosure 12. The first coating and adhesive assembly 51 and the second coating and adhesive assembly 53 may be employed to structurally couple or bond the enclosure 12 with cans of the battery cells 14, electrically isolate the battery cells 14 from the enclosure 12, transfer heat from the battery cells 14 to the enclosure 12, or any combination thereof.

In some embodiments, the first side beam 40 including the first webbed assembly 18 and the second side beam 42 including the second webbed assembly 20 may form parts of a boundary of the enclosure interior 16. In other embodiments, a first panel 52 may be disposed adjacent the first side beam 40 and a second panel 54 may be disposed adjacent the second side beam 42, where the first panel 52 and the second panel 54 form parts of the boundary of the enclosure interior 16. In either embodiment, a portion of the first webbed assembly 18 may be configured to collapse in response to the first force 26 (e.g., first side pole force) against the first side beam 40, and a portion of the second webbed assembly 20 may be configured to collapse in response to the second force 28 (e.g., second side pole force) against the second side beam 42. Specific architectures of the first webbed assembly 18 and the second webbed assembly 20 may be configured to improve energy absorption of the first force 26 and the second force 28, respectively. For example, as shown, certain interconnected elements of the first webbed assembly 18 may be more closely spaced adjacent the enclosure interior 16 (and, thus, the battery cells 14 disposed therein) than certain other interconnected elements of the first webbed assembly 18 further away from the enclosure interior 16. Likewise, certain interconnected elements of the second webbed assembly 20 may be more closely spaced adjacent the enclosure interior 16 (and, thus, the battery cells 14 disposed therein) than certain other interconnected elements of the second webbed assembly 20 further away from the enclosure interior 16. Further, in the illustrated embodiment, terminals 56, 58 of the battery cells 14 of the first stack 48 may be disposed opposite to bottoms 60 of the battery cells 14 of the first stack 48, where the bottoms 60 of the battery cells 14 face the first side beam 40 and corresponding first webbed assembly 18. Similarly, bottoms 60 of the battery cells 14 of the second stack 50 may face the second side beam 42 and corresponding second webbed assembly 20. Although other arrangements are also possible, the arrangement in FIG. 2 may protect the terminals 56, 58 of the battery cells 14 from impact by the forces 26, 28 (e.g., side pole forces) against the battery pack 10.

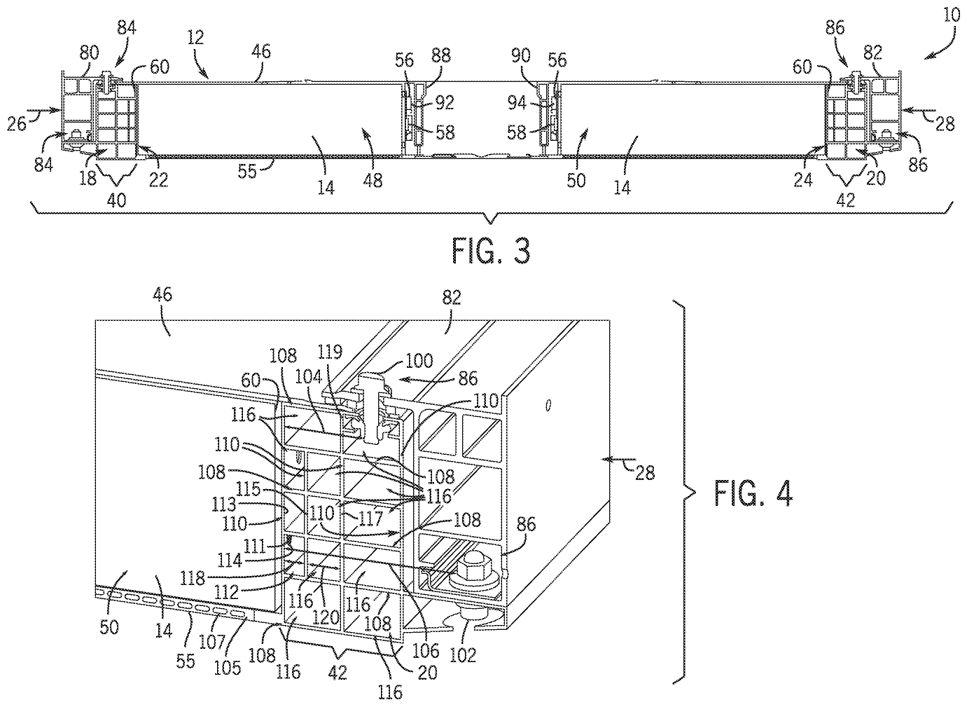

FIG. 3 is a cross-sectional front view of an embodiment of the battery pack 10 of FIG. 1, including features configured to integrate the battery pack 10 with a structure corresponding to a load powered by the battery pack 10. As an example, the battery pack 10 may be configured to power various aspects of a vehicle. A first body sill structure 80 and a second body sill structure 82 may correspond to a structure of the load (e.g., the vehicle). In some embodiments, the first body sill structure 80 may be coupled with the second body sill structure 82. As shown in FIG. 3, a first fastening assembly 84 may be configured to couple the first side beam 40 with the first body sill structure 80, and a second fastening assembly 86 may be configured to couple the second side beam 42 with the second body sill structure 82.

Each of the first and second fastening assemblies 84, 86 may include a two-plane fastening approach, described in detail below with reference to FIG. 4, which may improve reaction forces and moments for absorbing and/or mitigating mechanical loads (e.g., side pole forces, torsional loads, bending loads, etc.) against or associated with the battery pack 10. In general, traditional batteries for certain loads (e.g., vehicles) may be designed to protect the battery pack 10 from being impacted by forces associated with the loads (e.g., vehicles). Presently disclosed embodiments of the battery pack 10 (and integrated thereof with a load powered by the battery pack 10) may be designed such that the battery pack 10 receives and absorbs/mitigates certain mechanical loads or forces (e.g., side pole forces, torsional loads, bending loads, etc.). Further, presently disclosed embodiments designed as set forth above may reduce an overall weight associated with the battery pack 10 and the load.

As shown in FIG. 3, the terminals 56, 58 of the battery cells 14 may be disposed near a center of the battery pack 10 (e.g., within the enclosure 12). As previously described, the illustrated location of the terminals 56, 58 may protect the terminals 56, 58 from forces 26, 28 (e.g., side pole forces) against the system. In some embodiments, inner webbed structures 88, 90 may extend between the lid 46 of the enclosure 12 and the bottom side 55 (e.g., heat exchanger side) of the enclosure 12. Further, in certain embodiments, one or more first shunts 92 may extend over tops of the terminals 56, 58 (and/or bus bars) of the first stack 48 of battery cells 14, and one or more second shunts 94 may extend over tops of the terminals 56, 58 (and/or bus bars) of the second stack 50 of battery cells 14. The inner webbed structures 88, 90 and/or the shunts 92, 94 may provide additional protection to the terminals 56, 58 (and/or bus bars) of the first and second stacks 48, 50 of battery cells 14, respectively.

FIG. 4 is a cross-sectional perspective view of an embodiment of the battery pack 10 of FIG. 1, illustrating the second stack 50 of battery cells 14, the second side beam 42 (e.g., second extruded side beam) and corresponding second webbed assembly 20, and the second body sill structure 82 coupled to the second side beam 42 via the second fastening assembly 86. As previously described, the second fastening assembly 86 may employ a two-plane approach, which may improve reaction forces and moments for absorbing and/or mitigating mechanical loads (e.g., side pole forces, torsional loads, bending loads, etc.), such as the second side pole force 28, against the battery pack 10 (e.g., against and through the second body sill structure 82).

For example, the second fastening assembly 86 may include a first fastener 100 (e.g., first nut and bolt assembly) coupling the second body sill structure 82 with the second side beam 42 and a second fastener 102 (e.g., second nut and bolt assembly) coupling the second body sill structure 82 with the second side beam 42. The first fastener 100 may be coupled to the second side beam 42 at a first location toward a top of the second side beam 42 (and/or a first distance 104 from the battery cell 14 of the second stack 50), and the second fastener 102 may be coupled to the second side beam 42 at a second location toward a bottom of the second side beam 42 (and/or at a second distance 106 from the battery cell 14 of the second stack 50, where the second distance 106 is greater than the first distance 104). This arrangement may be referred to herein as a two-plane arrangement of the second fastening assembly 86. In the illustrated embodiment, the first fastener 100 also couples the lid 46 of the enclosure 12 with the second side beam 42 and the second body sill structure 82. In certain embodiments, the lid 46 may correspond to a floor panel of the load (e.g., the vehicle), and/or the first fastener 100 may extend through both the lid 46 and the floor panel. Although not shown in the illustrated embodiment, it should be noted that the first fastening assembly 84 (e.g., in FIG. 3) may include the same or similar two-plane arrangement as the second fastening assembly 86 in FIG. 4.

Continuing with FIG. 4, the battery cells 14 may be disposed between the lid 46 of the enclosure 12 and the bottom side 55 (e.g., heat exchanger side) of the enclosure 12. The bottom side 55 of the enclosure 12 may include a heat exchanger 105 formed therein and including channels 107 configured to receive a heat exchange fluid, where the heat exchanger 105 is configured to receive heat generated by the battery cells 14 and the heat exchange fluid is configured to carry the heat to a different location. In some embodiments, the battery pack 10 also may be configured to transfer heat from the battery cells 14 toward the lid 46. Further, the battery pack 10 may be designed such that the lid 46 and the bottom side 55 of the enclosure 12 are structurally coupled to cans of the battery cells 14, such that mechanical loads or forces received by the enclosure 12 are at least partially transmitted to the cans of the battery cells 14. Such a configuration, in addition to various features (e.g., the second side beam 42 and corresponding second webbed assembly 20) configured to mitigate mechanical loads or forces received by the battery pack 10, may reduce an overall weight of the system (e.g., the battery pack 10 and load powered by the battery pack 10) relative to traditional embodiments.

As previously described, the second webbed structure 20 corresponding to the second side beam 42 may include various horizontal interconnected elements 108 and various vertical interconnected elements 110, where the horizontal and vertical interconnected elements 108, 110 intersect to form the webbed structure 20. As shown, certain ones of the vertical interconnected elements 110 may be more closely spaced at a location adjacent to the battery cells 14 of the second stack 50 than at a location further away from the battery cells 14 of the stack 50. For example, the vertical interconnected elements 110 include a first vertical interconnected element 113, a second vertical interconnected element 115, a third vertical interconnected element 117, and a fourth vertical interconnected element 119 in the illustrated embodiment. The first vertical interconnected element 113 and the second vertical interconnected element 115 may be spaced by a first distance 121, the second vertical interconnected element 115 and the third vertical interconnected element 117 may be spaced by a second distance 123, and the third vertical interconnected element 117 and the fourth vertical interconnected element 119 may be spaced by a third distance 125 (e.g., where the distances 121, 123, 125 are measured parallel with, for example, the lid 46 and/or the bottom side 55 of the enclosure 12).

In the illustrated embodiment, the third distance 125 is greater than the second distance 123, and the second distance 123 is greater than the first distance 121. For example, the third distance 125 may be between 1.25 and 3 times the size of the second distance 123, and the second distance 123 may be between 1.25 and 3 times the size of the first distance 121. Such an arrangement may improve an ability of the second webbed structure 20 to absorb and/or mitigate forces (e.g., the second side pole force 28) prior to said forces impacting the battery cells 14. Further, the horizontal interconnected elements 108 and vertical interconnected elements 110 may intersect to form various channels or enclosed pockets (e.g., having rectangular cross-sectional shapes) of a medium, such as air, having a density that is less than a density of the interconnected elements 108, 110. The channels or enclosed pockets include, for example at least one venting channel 112. As shown, a vent opening 114 through the corresponding vertical interconnected element 110 may enable gases to vent from vents 111 of one or more of the battery cells 14 into the venting channel 112 (e.g., during an abnormality). Additional channels 116 may be disposed above, below, and/or beside the venting channel 112. A width 118 of the venting channel 112 may be less than an additional width 120 of the additional venting channel 116 immediately beside the venting channel 112 (e.g., where the width 118 and the additional width 120 are measured substantially parallel with, for example, the lid 46 and/or the bottom side 55 of the enclosure 12).

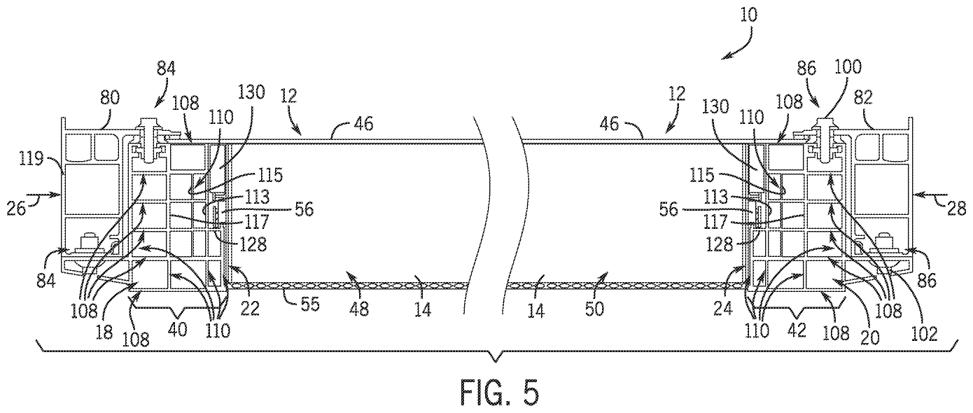

As shown in FIG. 4, bottoms 60 of the battery cells 14 of the second stack 50 may be disposed adjacent to (or face) the second side beam 42, with terminals on an opposing side of the bottoms 60 of the battery cells 14. In other embodiments, one or more terminals of the battery cells 14 may face the second side beam 42. For example, FIG. 5 is a cross-sectional front view of an embodiment of the battery pack 10 of FIG. 1, including the first stack 48 of battery cells 14 and the second stack 50 of battery cells 14. The battery cells 14 of the first stack 48 may include one terminal 56 facing the first side beam 40 and another terminal (not shown) on an opposing side of the battery cell 14. Likewise, the battery cells 14 of the second stack 50 may include one terminal 56 facing the second side beam 42 and another terminal (not shown) on an opposing side of the battery cell 14.

Shunt features may be employed to protect the terminals 56 of the first stack 48 of battery cells 14 and the second stack 50 of battery cells 14 from the forces 26, 28 (e.g., side pole forces), respectively, in FIG. 5. The shunt features may also protect bus bars of the battery pack 10. Loads may be shunted above and below the terminals 56. For example, focusing on the first stack 48 of battery cells 14, one horizontal interconnected element 128 of the horizontal interconnected elements 108 corresponding to the first side beam 40 (e.g., first extruded side beam) may extend underneath the terminal 56 of the battery cell 14 of the first stack 48, and a shunt block 130 may be disposed above the terminal 56. Similar features may be employed with respect to the second stack 50 of battery cells 14, as shown. The horizontal interconnected element 128 and the shunt block 130 may force loads (e.g., side pole forces 26, 28) away from the terminals 56 and to the cans of the battery cells 14.

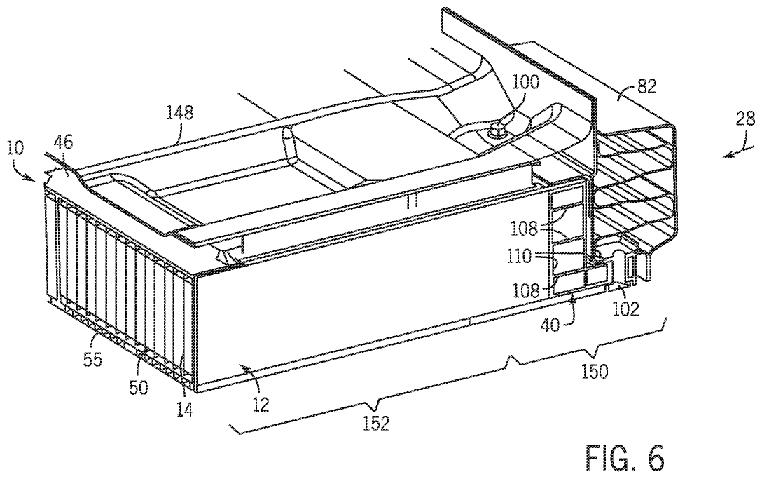

FIG. 6 is a cross-sectional perspective view of another embodiment of the battery pack 10 of FIG. 1 and structural componentry corresponding to a load powered by the battery pack 10 (e.g., the second body sill structure 82, a floor panel 148 corresponding to a vehicle, etc.). In the illustrated embodiment, a deformable zone 150 is formed by a portion of the battery pack 10 and the second body sill structure 82 corresponding to the load (e.g., vehicle). In response to the force 28 (e.g., side pole force), aspects of the deformable zone 150 are configured to collapse or otherwise absorb energy corresponding to the force 28. That is, aspects of the deformable zone 150, including at least the second body sill structure 82 and the second side beam 42 of the battery pack 10, may oppose the force 28 and block the force 28 from substantially impacting, for example, the battery cells 14 in the enclosure 12 of the battery pack 10.

As previously described, the load may correspond to a vehicle powered by the battery pack 10, where the vehicle, the battery pack 10, or both must pass certain regulatory testing related to force conditions experienced by the vehicle. In general, the deformable zone 150 is designed, as described at length in the present disclosure, to absorb a sufficient magnitude of the force 28, which may be dictated by the above-described regulatory testing, such that the safety cage 152 and componentry therein are not substantially impacted and by the force 28, and such that the regulatory testing standards can be met.

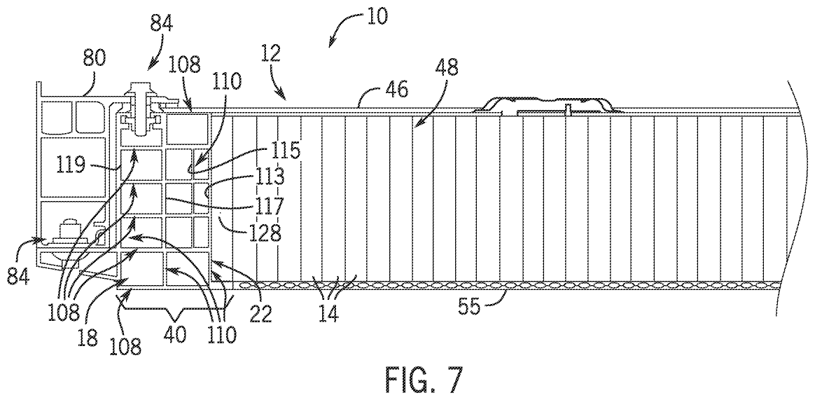

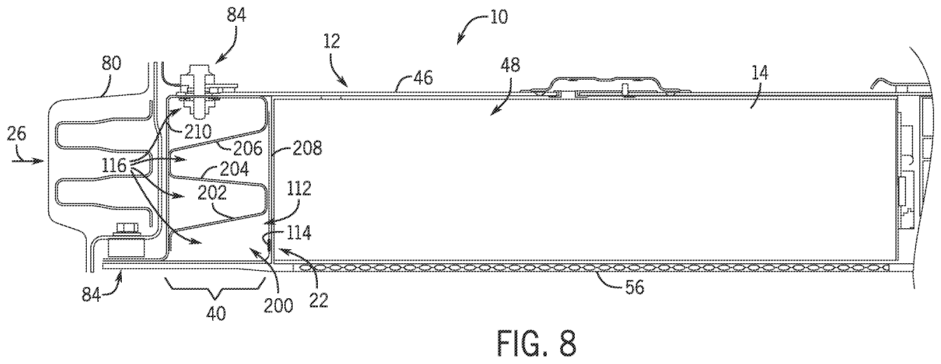

FIG. 7 is a cross-sectional front view of an embodiment of a portion of the battery pack 10 of FIG. 1. In the illustrated embodiment, the battery cells 14 of the stack 48 are oriented differently than shown in certain earlier embodiments. That is, the battery cells 14 in FIG. 7 are rotated 90 degrees related to the battery cells 14 in FIGS. 2-6, such that neither the terminals (not shown) nor the bottoms (not shown) of the battery cells 14 are disposed adjacent the first side beam 40 (e.g., first extruded side beam). That is, the first side beam 40 contacts (or is disposed immediately adjacent to) a broad face of each battery cell 14 adjacent the first side 22 of the enclosure 12. As shown, the first side beam 40, including the vertically oriented interconnected elements 110 and the horizontally oriented interconnected elements 108, may be the same as (or similar to) earlier embodiments. In certain embodiments or implementations, FIG. 7 may provide a greater stiffness for greater load reaction than other types of arrangements. Further, as the battery cells 14 swell during operation, stiffness of the stack 48 may increase in the illustrated arrangement. In the embodiment of FIG. 7, each battery cell 14 may include two terminals (not shown) extending from a single side of the respective battery cell 14, or a first terminal (not shown) on a first side and a second terminal (not shown) on a second side of the respective battery cell 14.

FIG. 8 is a cross-sectional front view of an embodiment of a battery pack 10 having a side beam 40 with sheet metal 200. The sheet metal 200, which may be stamped, roll formed, or shaped via some other manufacturing process, may be configured to collapse in response to a force 28 against the side beam 40 and/or the first body sill structure 80 adjacent the side beam 40. Although only one side of the battery pack 10 (e.g., including the first stack 48 of battery cells 14) is shown in the illustrated embodiment, it should be understood that an opposing side of the battery pack 10 may include an additional stack of battery cells and an additional instance of the sheet metal 200. In general, the illustrated sheet metal 200 may include an accordion or snake-like shape, as shown. In the illustrated embodiment, the sheet metal 200 includes three segments 202, 204, 206 traversing between sides 208, 210 of the side beam 40. The sides 208, 210 may also be formed by the same or an additional segment of the sheet metal 200.

The segments 202, 204, 206 may be referred to as reinforcement structures configured to collapse (e.g., partially or fully collapse) in response to the force 26 or other mechanical loads/forces on the battery pack 10. As described with respect to other embodiments of the present disclosure, the collapsing or crushing of the sheet metal 200 of the side beam 40 may be a progressive, sequence independent collapsing or crushing. In certain embodiments, the reinforcement structures 202, 204, 206 may define channels 116 formed in the side beam 40, where the channels 116 include a venting channel 112 fluidly coupled with an opening 114 (e.g., in the side 208 of the side beam 40) and configured to receive vented gases from the battery cells 14 of the stack 48, as previously described with respect to earlier embodiments.

The present disclosure is directed toward various embodiments of a battery pack that provide various technical benefits over traditional systems and methods, including improved support against mechanical loads, among other benefits.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery pack, comprising:
an enclosure defining an enclosure interior;
a stack of battery cells disposed in the enclosure interior between a first wall of the enclosure and a second wall of the enclosure; and
a side beam extending from the first wall to the second wall and adjacent to the stack of battery cells, wherein the side beam comprises a plurality of interconnected elements forming a web, and a portion of the web is configured to collapse in response to a force against a side of the battery pack exceeding a threshold force.

2. The battery pack of claim 1, wherein the plurality of interconnected elements defines a plurality of channels comprising:
a venting channel adjacent to the stack of battery cells; and
an additional channel disposed outward from the venting channel such that the venting channel is between the additional channel and the stack of battery cells.

3. The battery pack of claim 2, wherein a width of the venting channel is less than an additional width of the additional channel, and the width and the additional width extend substantially parallel to a plane corresponding to the first wall of the enclosure.

4. The battery pack of claim 2, comprising:
a vent opening disposed in an interconnected element of the plurality of interconnected elements; and
a vent disposed in a battery cell of the stack of battery cells, wherein the vent is fluidly coupled with the venting channel via the vent opening.

5. The battery pack of claim 2, wherein the venting channel comprises a rectangular shape defined by a first vertical interconnected element of the plurality of interconnected elements, a second vertical interconnected element of the plurality of interconnected elements, a first horizontal interconnected element of the plurality of interconnected elements, and a second horizontal interconnected element of the plurality of interconnected elements.

6. The battery pack of claim 1, wherein the stack of battery cells is arranged in the enclosure interior such that a terminal of at least one battery cell of the stack of battery cells faces the side beam.

7. The battery pack of claim 6, comprising a shunt disposed between the stack of battery cells and the portion of the side beam, wherein the shunt is configured to protect the terminal from the portion of the web collapsing in response to the force against the side of the battery pack exceeding the threshold force.

8. The battery pack of claim 1, wherein:
at least one battery cell of the stack of battery cells comprises a first surface, a second surface opposing the first surface, and a terminal protruding from the second surface; and
the first surface faces the side beam.

9. The battery pack of claim 1, comprising:
a first fastener configured to couple the side beam to a body sill structure of a load powered by the battery pack; and
a second fastener configured to couple the side beam to the body sill structure of the load powered by the battery pack.

10. The battery pack of claim 9, wherein:
the first fastener is configured to couple a first location of the side beam to the body sill structure and the first location is a first distance away from the stack of battery cells; and
the second fastener is configured to couple a second location of the side beam to the body sill structure and the second location is a second distance away from the stack of battery cells;
the first distance and the second distance extend substantially parallel to a plane corresponding to the first wall of the battery pack; and
the second distance is greater than the first distance.

11. The battery pack of claim 1, wherein the stack of battery cells is structurally bonded to and electrically isolated from the first wall of the enclosure and the second wall of the enclosure.

12. An enclosure assembly of a battery pack, the enclosure assembly comprising:
a body portion defining an enclosure interior configured to receive a plurality of battery cells;
a lid configured to be coupled to the body portion to enclose the plurality of battery cells within the enclosure interior; and
a side beam coupled to or forming a part of the body portion such that the side beam extends from a bottom of the body portion to the lid, wherein the side beam comprises a plurality of interconnected elements forming a web, and a portion of the web is configured to collapse in response to a force against the side beam exceeding a threshold force.

13. The enclosure assembly of claim 12, comprising:
a first fastener configured to couple an upper location of the side beam to a body sill structure of a load powered by the battery pack; and
a second fastener configured to couple a lower location of the side beam to the body sill structure of the load powered by the battery pack.

14. The enclosure assembly of claim 12, comprising an additional side beam coupled to or forming an additional part of the body portion such that the additional side beam extends from the bottom of the body portion to the lid and such that the enclosure interior is positioned between the side beam and the additional side beam, wherein the additional side beam comprises an additional plurality of interconnected elements forming an additional web, and an additional portion of the additional web is configured to collapse in response to an additional force against the additional side beam exceeding the threshold force.

15. The enclosure assembly of claim 12, comprising:
a venting channel adjacent to the enclosure interior and defined by a first set of interconnected elements of the plurality of interconnected elements;
a vent opening in an interconnected element of the first set of interconnected elements, wherein the vent opening is fluidly coupled with the venting channel; and
an additional channel defined by a second set of interconnected elements of the plurality of interconnected elements, wherein the additional channel is disposed outward from the venting channel such that the venting channel is between the additional channel and enclosure interior, a width of the venting channel is less than an additional width of the additional channel, and the width and the additional width extend substantially parallel to a plane corresponding to the lid of the enclosure.

16. A battery pack, comprising:
an enclosure defining an enclosure interior;
a first side beam defining a first side of the enclosure and including first sheet metal, wherein a first portion of the first sheet metal is configured to controllably collapse in response to a first force against the first side beam;
a second side beam defining a second side of the enclosure and including second sheet metal, wherein a second portion of the second sheet metal is configured to controllably collapse in response to a second force against the second side beam;
a lid of the enclosure, wherein the lid extends from the first side beam to the second side beam;
a wall of the enclosure opposing the lid of the enclosure, wherein the wall extends from the first side beam to the second side beam; and
a plurality of battery cells disposed in the enclosure interior between the first side beam and the second side beam, wherein the plurality of battery cells is structurally coupled to and electrically isolated from the lid and the wall.

17. The battery pack of claim 16, comprising:
a first stack of battery cells formed by a first portion of the plurality of battery cells, wherein the first stack of battery cells is disposed in the enclosure interior adjacent to the first side beam;
a second stack of battery cells formed by a second portion of the plurality of battery cells, wherein the second stack of battery cells is disposed in the enclosure interior adjacent to the second side beam; and
a central cavity in the enclosure interior, wherein the central cavity forms a gap between the first stack of battery cells and the second stack of battery cells.

18. The battery pack of claim 16, comprising:
a first two-plane fastener assembly configured to couple the first side beam with a body sill structure at a first location and a second location; and
a second two-plane fastener assembly configured to couple the second side beam with the body sill structure at a third location and a fourth location.

19. The battery pack of claim 16, comprising:
a first plurality of channels formed by the first side beam, wherein the first plurality of channels comprises a first venting channel fluidly coupled with first vents of the plurality of battery cells via a first vent opening in the first side beam; and
a second plurality of channels formed by the second side beam, wherein the second plurality of channels comprises a second venting channel fluidly coupled with second vents of the plurality of battery cells via a second vent opening in the second side beam.

20. The battery pack of claim 19, wherein:
the first sheet metal of the first side beam is arranged in a first accordion or snake-like shape; and
the second sheet metal of the second side beam is arranged in a second accordion or snake-like shape.
